(19) United States
(12) Patent Application Publication
(10) Pub. No.: US 2012/0247022 A1
(43) Pub. Date: Oct. 4, 2012

(54) DETACHABLE FASTENER FOR SLIDING PANELS

(76) Inventor: Sean T. McDonough, Salem, NH (US)

(21) Appl. No.: 13/077,852

(22) Filed: Mar. 31, 2011

(51) Int. Cl. E05B 65/08; E05C 19/18; E06B 3/46

(52) U.S. Cl. 49/370; 292/288

(57) ABSTRACT

A panel fastening system includes a first panel unit having a first glass panel mounted within a first frame, a second panel unit having a second glass panel mounted within a second frame, and a detachable fastener. The detachable fastener includes a bracket configured to be positioned on a jamb of the first frame, a suction cup configured to be fastened to the second glass panel, and a joining link having one end coupled to the suction cup and another end coupled to the bracket for urging the first frame against the second frame.

### FIELD

This disclosure relates generally to sliding panels such as sliding glass doors and windows and more particularly to a detachable fastener for the same.

### BACKGROUND

Sliding panel assemblies may include sliding glass doors and windows. Each includes a frame with a glass panel mounted within the frame. One or both to of the frames may be capable of sliding in a respective wall frame. For instance, a sliding glass door assembly may include a fixed door and a sliding door mounted within a wall frame.

Sliding panel assemblies may be subject to great temperature differentials between interior and exterior temperatures, especially in cold weather climates. In addition, differing materials used for the glass panel frames may have different coefficients of thermal expansion causing stress between such materials as they contract and expand at different rates. Such temperature stresses, as well as other problems such as installation defects and normal wear and tear, may cause an air gap to form between the two glass panel frames when the sliding panel assembly is in a closed position. This air gap leads to undesirable heat transfer and substantial heat loss in cold climates.

One conventional method of alleviating such heat loss is to position plastic shrink wrap about the glass panel frames and then fill the air gap between the shrink wrap and the sliding panels with warm air. A drawback with this conventional method is that there is no access to the sliding panel assemblies for regular use once the shrink wrap is in position. For example, a sliding glass door would be inaccessible for entry and exit.

Another conventional method of alleviating heat loss is in material selection and design for the sliding panel frames. Such panel frames may be fabricated of different extruded materials where hollow cavities can be formed to further define air pockets that act as insulation. Although effective, a home owner would need to purchase an entire sliding panel assembly and install the same to enjoy the benefits of such frames.

Yet another conventional method of alleviating heat loss when the sliding panels include sliding glass doors is to install a complex lock mechanism within an existing sliding glass door assembly. In addition to providing for security against intruders, the lock mechanism also provides a means for minimizing heat loss by drawing the door frames together. However, a drawback of this mechanism is the complexity and cost associated with retrofitting an existing sliding door assembly with such a lock mechanism. In addition, tools would be necessary to bore a hole through each door frame and to properly align, secure, and assemble the locking mechanism therein.

Accordingly, it would be desirable to provide a detachable fastener for sliding panels which overcomes the above-described inadequacies and shortcomings.

### SUMMARY

According to a first aspect of the disclosure a panel fastening system is provided. The panel fastening system includes a first panel unit having a first glass panel mounted within a first frame, a second panel unit having a second glass panel mounted within a second frame, and a detachable fastener. The detachable fastener includes a bracket configured to be positioned on a jamb of the first frame, a suction cup configured to be fastened to the second glass panel, and a joining link having one end coupled to the suction cup and another end coupled to the bracket for urging the first frame against the second frame.

According to yet another aspect of the disclosure, a detachable fastener is provided. The detachable fastener includes a bracket configured to be positioned on a jamb of a first frame having a first glass panel mounted within the first frame, a suction cup configured to be fastened to a second glass panel mounted within a second frame, and a joining link having one end coupled to the suction cup and another end coupled to the bracket for urging the first frame against the second frame.

The present disclosure will now be described in more detail with reference to exemplary embodiments as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

For a better understanding of the present disclosure, reference is made to the accompanying drawings, in which like elements are referenced with like numerals, and in which:

FIG. 1 is an interior elevation view of a sliding door assembly having two detachable fasteners consistent with an embodiment of the disclosure;

FIGS. 2A and 2B are a cross sectional views taken along the line 2-2 of FIG.

FIG. 3 is a schematic view of another embodiment of a detachable fastener consistent with an embodiment of the disclosure; and

FIG. 4 is a schematic view of yet another embodiment of a detachable fastener consistent with an embodiment of the disclosure.

### DETAILED DESCRIPTION

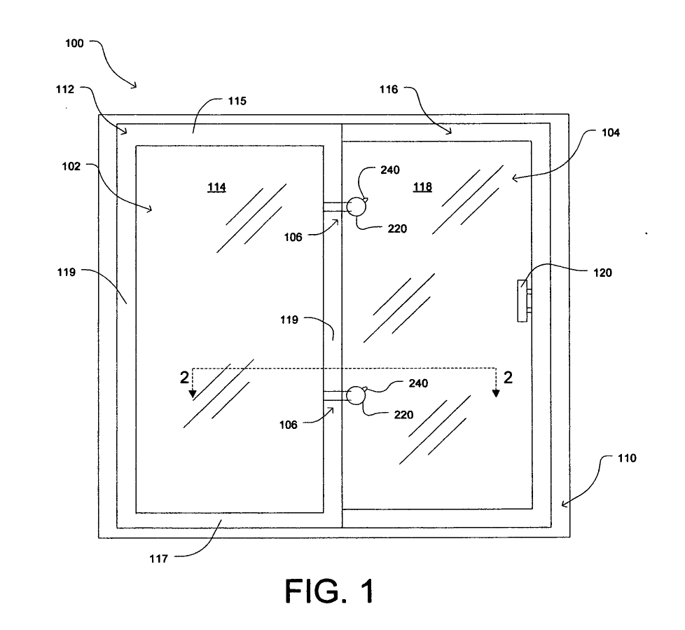

FIG. 1 illustrates a sliding panel assembly 100 having a fixed panel unit 102 and a sliding panel unit 104 and two detachable fasteners 106 consistent with the present disclosure. The sliding panel assembly 100 is illustrated as a sliding glass door assembly and will be described as such herein although those skilled in the art will recognize the detachable fasteners 106 may be used with other sliding panel assemblies such as sliding windows.

The fixed panel unit 102 includes a frame 112 extending about its periphery with a glass panel 114 mounted within the frame 112. The frame 112 includes a head 115, a sill 117, and jambs 119. Similarly, the sliding panel unit 104 includes a frame 116 extending about its periphery with a glass panel 118 mounted within the frame 116. The sliding panel unit 104 further includes a handle 120. Each unit 102, 104 is further mounted in a door frame 110 attached to a building structure with the sliding panel unit 104 mounted for sliding movement on a track of the door frame 110.

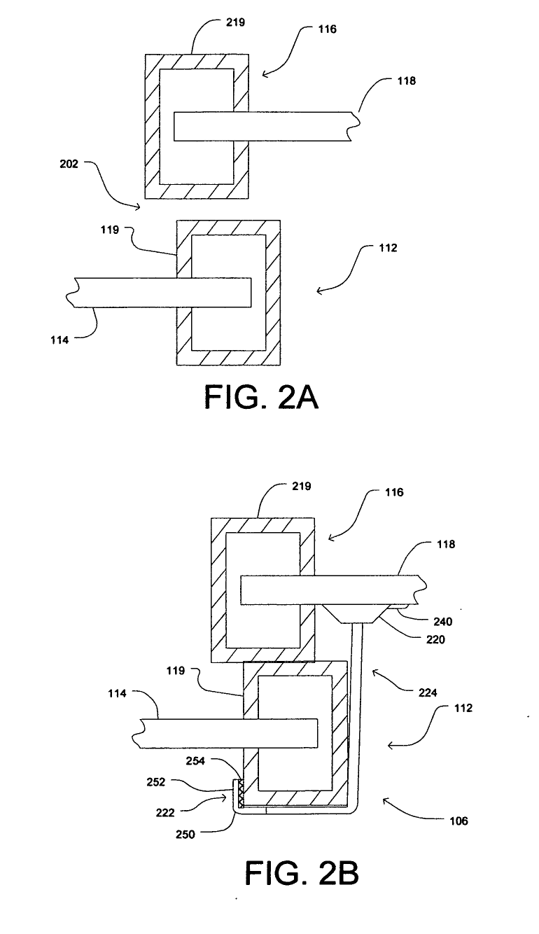

FIG. 2A is a cross sectional view taken along the line 2-2 of FIG. 1 without a detachable fastener and FIG. 2B is a cross sectional view taken along the line 2-2 of FIG. 1 with a detachable fastener 106 consistent with an embodiment of the disclosure. As illustrated in FIG. 2A, when the sliding unit 104 is in a closed position, an undesirable air gap 202 may exist between a jamb 219 of the frame 116 of the sliding unit 102, and a jamb 119 of the frame 112 of the fixed unit 102. This undesirable air gap 202 may lead to excessive heat transfer and heat loss in cold climates. Advantageously, as illustrated in FIG. 2B, the detachable fastener 106 is readily fastened between the glass panel 118 and the jamb 119 of the fixed unit 102 to urge the frames 112, 116 against each other. As such, the undesirable air gap 202 of FIG. 2A and associated heat transfer is minimized.

More particularly, as illustrated in FIG. 2B, the detachable fastener 106 may include a suction cup 220 configured to be fastened to the glass panel 118, a bracket 222 configured to be positioned on the jamb 119, and a joining link 224 having one end coupled to the suction cup 220 and another end coupled to the bracket 222 for urging the jamb 219 of the frame 116 of the sliding unit 102 against the jamb 119 of the frame 112 of the fixed unit 102. The suction cup 220 may further include a release tab 240 to facilitate release of the same from the glass panel 118. The diameter of the suction cup may be at least one inch to provide sufficient adhesion to the glass panel 118. The bracket 222 may have a ninety degree bend 250 defining an arm 252. A pad 254 may be disposed on an interior surface of the arm 252 to contact the jamb 119. In one embodiment, the pad 254 may be a pliable nonabrasive material to protect the finish of the jamb 119 and to promote adhesion thereto without slipping when subject to sufficient force. The joining link 224 may be fabricated of differing materials. The joining link 224 may include a ribbon fabricated of nylon, plastic, or rubber. The joining link 224 may also include a spring (not illustrated) that can be stretched to accommodate varying distances between the glass panel 118 and the jamb 119 of differing sliding panel assemblies. The spring also provides additional biasing force to urge the two frames together.

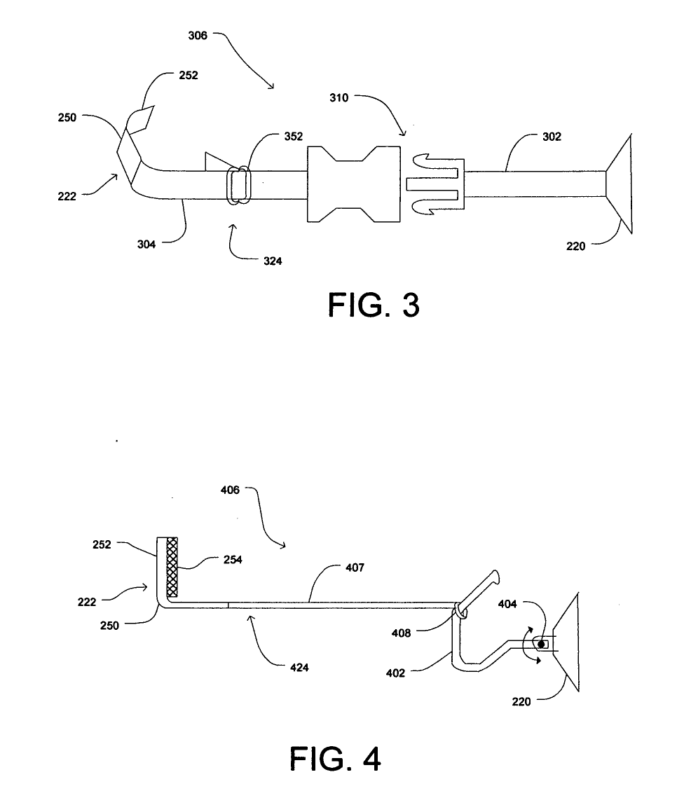

In operation, a user may quickly and easily attach the detachable fastener 106 to minimize an undesirable air gap 202 by fastening the suction cup 220 to the glass panel 118 and positioning the bracket 222 against a corner of the jamb 119. The tension in the detachable fastener 106 provides force to urge the jamb 219 of one frame 116 towards the jamb 119 of another frame 112. Advantageously, the detachable fastener 106 may also be quickly removed by releasing the suction cup 220 or removing the bracket 222 enabling users to open the sliding panel unit 104. The joining link of other embodiments may also have an additional release mechanism to facilitate removal of the detachable fastener as detailed with respect to FIGS. 3 and 4.

Turning to FIG. 3, a schematic perspective view of another embodiment of a detachable fastener 306 consistent with an embodiment is illustrated. In this embodiment, the joining link 324 connecting the suction cup 220 and the bracket 222 has a detachable mechanism to facilitate removal of the detachable fastener 306. More particularly, the detachable fastener 306 include a first ribbon 302 coupled to the suction cup 220 and a second ribbon 304 coupled to the bracket 222. A side release buckle 310 is coupled to each of the first and second ribbons 302, 304 to connect the first and second ribbons 302, 304 in an engaged position and to disconnect the first and second ribbon 302, 304 in a released position. The side release buckle 310 facilitates quick and easy removal of the detachable fastener by releasing tension on the suction cup 220 and bracket 222 when in a released position. An additional buckle 352 may be coupled to one of the ribbons such as the second ribbon 304 so the length of the second ribbon may be long enough to accommodate different size assemblies and provide flexibility to add clamping pressure by pulling on a loose end 305 of the second ribbon 304.

Turning to FIG. 4, a schematic view of another embodiment of a detachable fastener 406 consistent with an embodiment is illustrated. Similarly to FIG. 3, the joining link 424 also has a detachable mechanism to facilitate removal of the detachable fastener 406. More particularly, the suction cup 220 includes a hook 402 affixed thereto by a hinge 404. The joining link 424 includes a ribbon 407 coupled to a ring 408. The ring 408 is configured to mate with the hook 402 in an engaged position and to be removed from the hook 402 in a released position. The hinge 404 facilitates movement of the hook 402 to remove the ring 410. This hook 402 and ring 410 configuration also facilitates quick and easy removal of the detachable fastener 406 by releasing tension on the suction cup 220 and bracket 222 when in a released position.

Accordingly, there is thus provided a detachable fastener for sliding panels. The detachable fastener is an effective and inexpensive mechanism to minimize air gaps common in sliding panels such as sliding glass doors and windows. Accordingly, heat transfer is advantageously minimized. For example, in cold climate regions, this can result in substantial heating cost savings as heat losses are minimized. Furthermore, the detachable fastener also enables users to readily detach the fastener and open one of the sliding panels. Yet still, the detachable fastener does not require tools or machining any permanent attachments to existing frames.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A panel fastening system comprising:
a first panel unit having a first glass panel mounted within a first frame;
a second panel unit having a second glass panel mounted within a second frame; and
a detachable fastener comprising a bracket configured to be positioned on a jamb of the first frame, a suction cup configured to be fastened to the second glass panel, and a joining link having one end coupled to the suction cup and another end coupled to the bracket for urging the first frame against the second frame.

2. The panel fastening system of claim 1, wherein the suction cup comprises a release tab.

3. The panel fastening system of claim 1, wherein the joining link comprises a spring.

4. The panel fastening system of claim 1, wherein the joining link comprises a first ribbon coupled to the suction cup, a second ribbon coupled to the bracket, and a side release buckle coupled to each of the first and second ribbon, the side release buckle configured to connect the first and second ribbon in an engaged position and to disconnect the first and second ribbon in a released position.

5. The panel fastening system of claim 1, wherein the suction cup has a hook and the joining link comprises a ribbon coupled to a ring, the ring configured to mate with the hook in an engaged position and to be removed from the hook in a released position.

6. The panel fastening system of claim 1, wherein the bracket comprises a ninety degree bend and an arm, and wherein a pad is disposed on an interior surface of the arm to contact the jamb of the first frame.

7. A detachable fastener comprising:
a bracket configured to be positioned on a jamb of a first frame having a first glass panel mounted within the first frame;
a suction cup configured to be fastened to a second glass panel mounted within a second frame; and
a joining link having one end coupled to the suction cup and another end coupled to the bracket for urging the first frame against the second frame.

8. The detachable fastener of claim 7, wherein the suction cup comprises a release tab.

9. The detachable fastener of claim 7, wherein the joining link comprises a spring.

10. The detachable fastener of claim 7, wherein the joining link comprises a first ribbon coupled to the suction cup, a second ribbon coupled to the bracket, and a side release buckle coupled to each of the first and second ribbon, the side release buckle configured to connect the first and second ribbon in an engaged position and to disconnect the first and second ribbon in a released position.

11. The detachable fastener of claim 7, wherein the suction cup has a hook and the joining link comprises a ribbon coupled to a ring, the ring configured to mate with the hook in an engaged position and to be removed from the hook in a released position.

12. The detachable fastener of claim 7, wherein the bracket comprises a ninety degree bend and an arm, and wherein a pad is disposed on an interior surface of the arm to contact the jamb of the first frame.
